(19) United States
(12) Patent Application Publication
(10) Pub. No.: US 2008/0064333 A1
(43) Pub. Date: Mar. 13, 2008

(54) System and method for specifying observed targets and subsequent communication

(76) Inventor: Charles Martin Hymes, Eugene, OR (US)

Correspondence Address: CHARLES MARTIN HYMES, P.O. Box 50604, EUGENE, OR, 97405, US

(21) Appl. No.: 11/820,290

(22) Filed: Jun. 18, 2007

Related U.S. Application Data
(63) Continuation-in-part of application No. 11/279,546, filed on Apr. 12, 2006.
Application No. 11/279,546 is a continuation-in-part of application No. 11/061,940, filed on Feb. 19, 2005.
(63) Continuation-in-part of application No. 11/061,940, filed on Feb. 19, 2005.
(60) Provisional application No. 60/670,762, filed on Apr. 12, 2005.
(60) Provisional application No. 60/844,335, filed on Sep. 13, 2006.
(60) Provisional application No. 60/814,826, filed on Jun. 18, 2006.
(60) Provisional application No. 60/654,345, filed on Feb. 19, 2005.
(60) Provisional application No. 60/612,953, filed on Sep. 24, 2004.
(60) Provisional application No. 60/603,716, filed on Aug. 23, 2004.
(60) Provisional application No. 60/548,410, filed on Feb. 28, 2004.

(51) Int. Cl. H04B 7/00; H04Q 7/38

(52) U.S. Cl. 455/41.2; 455/414.3

(57) ABSTRACT

A system and method of facilitating communication, via a telecommunications system, among people that may perceive each other's physical presence, but may not know each other's identity or contact information (e.g., telephone number, e-mail address, etc.). A user indicates a target (another user or another user's vehicle) by specifying values of various observable features that unambiguously describe the target within the constraints of the target's location. Communication between two users may be mediated, and may be wholly or partially suspended unless it is initiated by both parties.

### CROSS REFERENCE TO RELATED APPLICATIONS

The present application is a Continuation-in-Part of U.S. application Ser. No. 11/279,546, filed Apr. 12, 2006, and also a Continuation-in-Part of U.S. application Ser. No. 11/061,940, filed Feb. 19, 2005, and claims the benefit of both of these applications as well as their parent applications. U.S. application Ser. No. 11/279,546 is a Continuation-in-Part of U.S. application Ser. No. 11/061,940 and claims the benefit of that application as well as of its parent applications; U.S. application Ser. No. 11/279,546 also claims the benefit of U.S. Provisional Application 60/670,762, filed Apr. 12, 2005. U.S. application Ser. No. 11/061,940 claims the benefit of U.S. Provisional Application 60/654,345, filed Feb. 19, 2005, U.S. Provisional Application 60/612,953, filed Sep. 24, 2004, U.S. Provisional Application 60/603,716, filed Aug. 23, 2004, and U.S. Provisional Application 60/548,410, filed Feb. 28, 2004, and also incorporates by reference the underlying concepts, but not necessarily the nomenclature, of these four provisional applications. The present application also claims the benefit of U.S. Provisional Application 60/844,335, filed Sep. 13, 2006; and the further benefit of U.S. Provisional Application 60/814,826, filed Jun. 18, 2006.

The underlying concepts, but not necessarily the nomenclature, of the above applications are incorporated by reference.

### FIELD OF THE INVENTION

The present invention relates to telecommunications in general, and, more particularly, to mobile social telecommunications.

### BACKGROUND

In recent years there has been a steady stream of innovation in wireless technologies to facilitate communications among people that share the same immediate environment. More specifically, there has been an evolution in a functional class of technologies that are here termed “Perceptual Addressing” in which a user is given the capability to specify to a wireless communications system or wireless network a particular target (person, vehicle, etc.) that the user observes, and in some cases would like to communicate with, even though the user has no contact information for the target.

One of the more common methods of perceptual addressing is described in separate patent applications from each of Salton, Karaizman, Hymes, and Libov & Pratt in which a user is presented with photographs of people that are in the user's immediate vicinity (determined by GPS, Bluetooth, RFID or some other related technology), each photograph linked with an ID or address of the person in the photo. The user then selects the photograph that corresponds with the person the user wants to contact, and in this way specifies that target person to the system.

Other methods have been described that include providing a user with a map displaying proximate targets; the user selects the representation on the map that corresponds with the person the user wants to contact (see Hymes or Karaizman). DeMont describes a system in which a user employs a directional antennae pointed at a target to receive the target's broadcasted ID/address; and Hymes describes a system in which a user points and beams a directional signal to the user's target. Karaizman, Bell, and Hymes each describe a system in which a user points a camera at a target and captures an image which is then analyzed with facial recognition technology to identify the target and the target's associated contact information. There is currently a system implemented in Japan in which a GPS system reports a user's position while a compass in the user's cellular telephone reports the direction the phone is pointing; reference to a map reveals to the system the target building that the user is pointing at.

Although these methods are technologically feasible, there are usability problems with many of these methods. A system that shows to users photographs of people in their immediate surroundings may cause people to feel uncomfortable with the idea that at any given moment a stranger in the same room may be viewing their photograph without their knowledge. Several other methods involve the indiscreet act of pointing a device at a person of interest. The map idea seems appealing until one considers the difficulty in associating a “scatter plot” of dots with actual people. The methods described in the present application overcome these weaknesses, while also addressing other issues.

### SUMMARY OF THE INVENTION

The primary purpose of this invention is to enable and facilitate social interaction among people that are within “perceptual proximity” of each other, i.e. they are physically close enough to each other that one person can perceive the other, either visually or aurally. The enhancements and additional embodiments within encompass additions to both (1) Perceptual Addressing and (2) Discreet Messaging (a form of communication at least partially conditional on a particular form of expressed mutual interest). As with previously described methods of Perceptual Addressing, the combination of any one of the Perceptual Addressing methods introduced in this application with a method of Discreet Messaging creates a result that is unique and greater than the sum of its parts: the breaking down of social barriers between strangers by providing the ability to safely express interest in a specific person perceived in one's immediate environment in a manner that eliminates both the fear of rejection and the risk of being an unwelcome annoyance.

### BRIEF DESCRIPTION OF THE DRAWINGS

### DETAILED DESCRIPTION

In the following detailed description of example embodiments of the invention, reference is made to the accompanying drawings which form a part hereof, and in which is shown by way of illustration specific sample embodiments in which the invention may be practiced. These example embodiments are described in sufficient detail to enable those skilled in the art to practice the invention, and it is to be understood that other embodiments may be utilized and that logical, mechanical, electrical, and other changes may be made without departing from the substance or scope of the present invention. The following detailed description is, therefore, not to be taken in a limiting sense, and the scope of the invention is defined only by the appended claims. More specifically, any description of the invention, including descriptions of specific order of steps, necessary or required components, critical steps, and other such descriptions do not limit the invention as a whole, but rather describe only certain specific embodiments among the various example embodiments of the invention presented herein. Further, terms may take on various definitions and meanings in different example embodiments of the invention. Any definition of a term used herein is inclusive, and does not limit the meaning that a term may take in other example embodiments or in the claims.

Part I—Perceptual Addressing

One of the primary tools of the invention described in the patent applications listed above is Perceptual Addressing—a general class of methods that provides people with the ability to electronically communicate with other people or vehicles that they see, even though identity and contact information may not be known. In this section, enhancements and additional embodiments are described.

Perceptual Addressing in this provisional patent application is described in a more precise manner than in previous descriptions. At the same time, all previously described methods of Perceptual Addressing are perfectly compatible with this slightly modified description. As such, this application claims all previously disclosed embodiments of Perceptual Addressing and Discreet Messaging under this more precise conceptualization. In this application, Perceptual Addressing may be understood as follows:
There are two essential, non-sequential tasks that are central to Perceptual Addressing.
   1. The user of a communications terminal specifies one target person or target vehicle, out of potentially many possible target persons/vehicles in the user's perceptual proximity, by expressing one or more of the target's distinguishing characteristic(s) to the user's communications terminal.

Perceptual proximity is here defined as a range of physical distances such that one person is in the perceptual proximity of another person if he or she can distinguish that person from another person using either the sense of sight or the sense of hearing. A distinguishing characteristic is any characteristic of the target person or target vehicle, experienced by the user, that distinguishes the target person or target vehicle from at least one other person or vehicle in the user's perceptual proximity.

The user of this invention can specify the target by expressing his or her perception of the distinguishing characteristic(s) in at least two ways: (1) Direct expression of a distinguishing characteristic of the target person/vehicle, or (2) Selection from presented descriptions of distinguishing characteristics of people/vehicles in the user's perceptual proximity. Examples of Direct Expression are: (a) the user expresses the target's relative position by pointing the camera on his or her device and capturing an image of the target; or (b) the user expresses the appearance of a license plate number by writing that number. Examples of Selection are: (a) the user selects one representation of position, out of several representations of position that are presented, that is most similar to the way the user perceives the target's position; (b) the user selects one image out of several presented that is most similar to the appearance of the target; (c) the user selects one voice sample out of several presented that is most similar to the sound of the target's voice.

The selection of a target person based upon distinguishing characteristics can occur in one or more stages, each stage possibly using a different distinguishing characteristic. Each stage will usually reduce the pool of potential target people/vehicles until there is only one person/vehicle left—the intended target person/vehicle.
2. An association is made between the expression of the distinguishing characteristic(s) of the target person/vehicle and an address or identification code (ID) of the target person/vehicle.

Examples of this association: (a) The act of pointing a camera (integrated in a user's device) at a target person (to capture biometric data) associates the relative position of the target person (distinguishing characteristic) as expressed by the user with the biometric profile of the target person. Then using a database, the biometric profile is found to be associated with the address of the target's terminal. (b) A data processing system sends to the user's device ten images linked with ten addresses of ten people in a user's perceptual proximity. The user compares his or her visual experience of the target person (distinguishing characteristic) with his or her visual experience of each of the ten images displayed on his or her device, and then expresses his or her experience of the appearance of the visual appearance of the target by choosing an image that produces the most similar visual experience. Because the ten images were already associated with ten telecommunication addresses, by selecting the image of the target, an association can immediately be made to the target's address. (c) A user points a camera at a target person and takes a picture, thus associating the experienced relative position of the target (distinguishing characteristic) with the captured image. But because there are several people in the image just captured, the user circles the portion of the image that produces a visual experience that is most similar to the experience of viewing the face of the target person (distinguishing characteristic). The image or the target person's face is subjected to a biometric analysis to produce a biometric profile. This profile is then found to be associated with the target person's telecommunications address in a database.

This associative process may occur on the user's terminal, on the terminals of other users, on a data processing system, or any combination. Once the correct address or ID of the intended recipient has been determined, the Perceptual Addressing task has been completed. There are no restrictions on the varieties of subsequent communication between terminals.

### New Embodiments to Perceptual Addressing

1) Use of Degraded, Distorted, Caricatured, or Otherwise Non-veridical Images

There is a class of perceptual addressing methods in which a user receives images of other people in the user's perceptual proximity in order to select the image that best matches the user's intended target of communications (the person or vehicle the user wishes to communicate with). One problem with these methods is the aversion that many people experience when contemplating allowing a stranger to view an image of themselves. The aversion is compounded when contemplating the possibility that the stranger viewing their image may devise a way to save the image for his or her own purposes.

One solution to this problem takes advantage of the distinction between the human processes of (a) detecting similarities and differences between sensory stimuli, and (b) recognizing a face or a voice. For example, if a user is in a cafe and is given an image of a man with a beard and an image of a woman with red hair, the user may recognize both people in the images as the people sitting at the table next to the user. In other words, after comparing the images with the people at the next table, the user comes to the instant state of belief that the images were derived from the people at the next table. On the other hand, if both images were sufficiently blurry so that the user couldn't recognize the people in either image, the user may still be able to determine that the man with the beard at the table next to the user is more similar to the blurry image of the man than the blurry image of the woman. In other words, the user could reasonably select the one blurry image that looks most like the man, even though the selected image is sufficiently blurry that the user does not come to the instant psychological state of belief that the image is derived from the man.

In this same way altered images that prevent recognition and therefore protect the identity of the person in the image can still be used to determine the “best match” to a user's intended target of communications. The user compares altered images of people in perceptual proximity to the user's intended target to determine which image best matches the target person. Images are good enough to select the image that best represents the intended target, but not good enough to positively identify the person in any of the images. The idea is going for a “best match” among the relatively few images of the relatively few people in the user's perceptual proximity—as opposed to going for “recognition” of the person in the image.

To more concretely specify the concept of “recognizability”, which is the property to be avoided in the images in this embodiment, the minimum requirement is that most people feel more comfortable allowing strangers to view, and possibly record, their altered image without their permission or knowledge—as compared with the image before it is altered—because the altered image looks substantially less like them than it did before it was altered. Altering an image in an effective manner has the potential to introduce an increased degree of uncertainty as to whether or not a particular image is derived from any particular person.

### Embodiment #1

making a captured image sufficiently blurry (out of focus) to make the person in the image unidentifiable, yet still allow the user to determine which of two people before him or her looks more like the blurry image. The user would use cues of coloring, shape, size to choose the image that best matches the intended target in the user's perceptual proximity. If the blurry image is generated the same day so that the target person is wearing the same clothes as the person in the image, it would be especially effective because it would allow the user to additionally use shape and color of clothing to help determine a best match—but because clothing is usually such a transient property of appearance, its presence in an image would usually not make the subject of an image more recognizable.

### Embodiment #2

“Pixilate” each image of proximal people to the extent that it renders the person in the image unrecognizable, yet leaves enough features that one image is more similar to the target person than another image. Use in the same way as the blurry image described above.

### Embodiment #3

Increase the contrast of each image to the extent that it renders the person in the image unrecognizable, yet leaves enough features (color, for example) that one image is more similar to the target person than another image. Use in the same way as the blurry image embodiment described above.

### Embodiment #4

Use caricatured portraits of proximal people that highlight distinctive features of each person in the same way that cartoonists create caricatures of famous people. No caricatured portrait should be rendered so veridically that a person could be recognized from the portrait. But the portrait should successfully capture distinctive details to the extent that a user would be able to easily determine which portrait, among a limited set of portraits in the user's perceptual proximity, best characterizes the user's intended target of communications.

### Embodiment #5

Use full-body or half-body images that include clothing, but remove/block faces or particular facial features. Two embodiments of methods for selectively blocking facial features are:

(a) Software that locates faces in images is commonly used in facial recognition software. It is then a trivial step, known to any person skilled in the art, to replace area identified as the face with a solid, un-modulated color or pattern which sufficiently obscures facial features. A user invoking Perceptual Addressing could determine the best match of target by comparing the body and clothes of the target to the body and clothes of the people in the images. In this way it can be determined which image corresponds to the target, yet it would be difficult to use any of the images to identify any individual: clothes are not permanently associated with individuals—people wear different articles of clothing every day in different combinations, and many people wear very similar clothes.

(b) Users capture images of themselves, and then manually, using well-known software techniques (exemplified in programs such as Adobe's PhotoShop or Microsoft's Paint), select the portion of the image that represents their face, or portions of the images that represent individual facial features, and then replace or alter the selected portions so that it becomes more difficult to identify the image as being derived from their face. For example, opaque black rectangles could be substituted for a person's eyes and mouth to decrease the similarity between the image and the person from which the image was derived. Yet at the same time, the person's clothes and body are at least partially visible and is the basis of matching the image to the intended target. In some ways this is the optimal solution because users then have precise control over the degree of distortion of their image that is necessary to achieve their own required level of comfort in distributing these images to strangers.

2) Perceptual Addressing to Target that is not Accompanied by a Communications Terminal

This is a class of methods which are a variation of all methods of perceptual addressing that do not require the cooperation of a communications terminal accompanying the target in determining a communications address or ID associated with the target. The embodiments in this class of methods therefore do not require that the target of communications, a particular person or vehicle, be accompanied by a communications terminal. Once a target address or ID has been determined, communications can then be directed to that address or ID.

Any communication can be received by the target at a later time when the target accesses communications directed to his or her communications address or ID. There is no limitation as to the target's type of communications address to which communications may be directed and may include email addresses, telephone numbers, IP addresses, physical street addresses, user names or ID's that are associated with addresses, etc.

### EXAMPLE #1

A woman uses a camera on her cell phone to capture a photograph of a man. She crops the image to include only his face, and sends the image along with a text message for him to a server. The server executes a facial recognition analysis of the image, and determines a biometric match to a person and an email address in its database. The server then forwards the text message to the email address. During the time the woman captures the photograph of the man, the man is not carrying a communications terminal. But later that evening, the man accesses the internet from a friend's computer, logs into his Yahoo email account and reads the message from the woman.

### EXAMPLE #2

People register, with a server via the internet, their presence, or intended presence, at a specific location at a specific time interval. Upon request, a server sends to a woman at that location the images of other people at that location along with an ID associated with each person. The woman selects the image of a man she wants to contact. Her communications terminal then sends the ID associated with the man along with a text message to the server. The server then makes the message from the woman available to the man when he later logs into a web site associated with the server.

3) Using Sets of Feature Descriptions to Specify a Person or Vehicle. [See USPTO Document Disclosure # 590924, Nov. 30, 2005]

This is a class of methods of Perceptual Addressing that employs clusters (or sets) of verbal or category-based descriptions of individual features of a person to enable a user to distinguish among people in the user's perceptual proximity.

For example, instead of specifying a person by using a photograph of that person, in this method the user would specify a person with a set of verbally expressed feature descriptions of the person's appearance—for example: female, tall, blonde hair, blue eyes. As an alternative example, the same description could be expressed with a set of image-based feature descriptions: a graphic symbol of a female, a tall skinny stick figure to indicated tallness, an image of long blonde hair, an image of a blue eye. [Individual feature descriptions could then optionally be combined to generate a single composite graphic representation. Combining image attributes is a capability well known in the art of image manipulation. In fact it is practiced by some law enforcement departments to enable the construction of an image of a crime suspect from eye-witness descriptions of that person.]

This class of Perceptual Addressing methods differs from other methods of Perceptual Addressing in at least two ways:

(a) In this method, although individual feature descriptions are chosen to specify the person they are intended to represent, no feature description itself is derived from the person they are intended to represent. For example, in the case that graphic feature descriptions are used, an illustration of a long thin nose may be used to describe the appearance of a target person's nose; but the illustration of the long thin nose was not derived from the appearance of the target person. In contrast, in many other methods of Perceptual Addressing, representations of the appearance of people are derived from the person they are intended to represent. For example, when a camera photographs a person in order to produce an image that can be used to represent the person, the image is derived from the person because the person is used in the process of generating the image. In the case that verbal feature descriptions are used, for example “blue eyes”, although the feature descriptions are chosen to represent a particular person, the words “blue” and “eyes” are not derived from the person. In fact blue is actually a value or category of color that describes the feature “eye” or the feature “eye color”.

(b) In this class of methods of Perceptual Addressing, descriptions of multiple features are employed to represent each person. For example, descriptions of the nose, eye color, chin, hair color, hair length, height and build are used to represent one person. In contrast, many other methods of Perceptual Addressing use a single image (which is not a category) to represent the appearance of a person, such as a photograph of the face of a person.

In this method of Perceptual Addressing, descriptions of multiple features of a person (or vehicle) are termed feature description clusters. Feature description clusters may describe not only attributes of appearance, but also attributes of activity, body position, clothing or accessories, voice quality, spatial location, or any other observable attribute of a person, including a description of an accompanying person, pet, vehicle, etc. (for example, a target may be described as “woman sitting in red convertible”).

Feature description clusters may be constructed in a variety of ways, and then once constructed, may be represented in a variety of ways; and may also be transformed. For example, a verbal feature description cluster may be transformed into a graphic feature description cluster in which each single verbal feature description is converted into a single graphic feature description (e.g. “blue eyes” is converted into an illustration of a blue eye); or a verbal cluster may be transformed into a single composite image (e.g. “female, tall, blue eyes, long hair, blonde hair, wavy hair, red shoes” is converted into a composite image—an illustration of a tall woman with blue eyes, long blonde wavy hair, and red shoes). This transformation can occur as each verbal feature description is added, or after the entire verbal feature description cluster is entered.

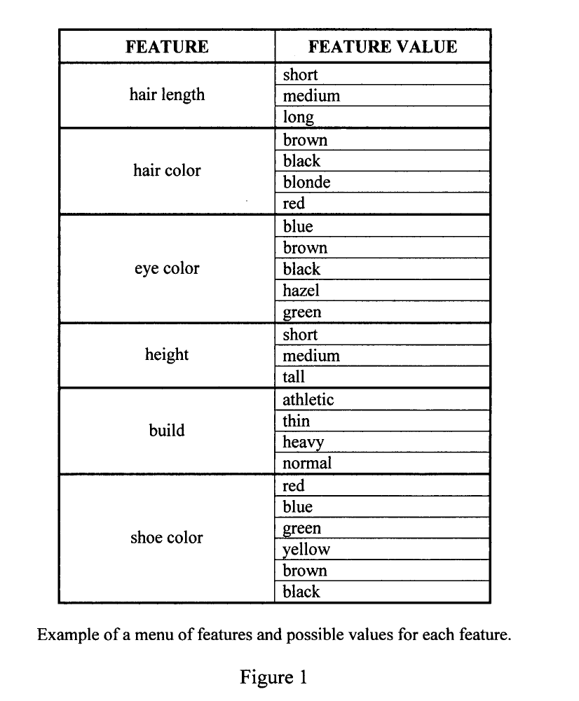

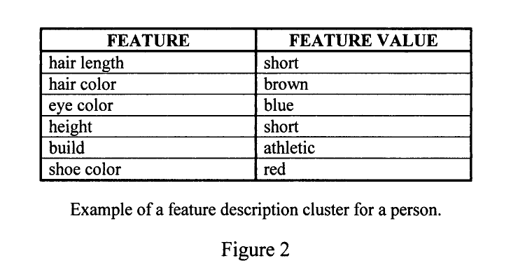

One technique for constructing a feature description cluster of a person is merely for a user to input text into a telecommunications terminal which consists of a series of descriptions of features of a person, each feature description separated by a comma. An alternative technique is one in which feature descriptions of a person are chosen from either a verbal menu or a graphic menu [see FIG. 1]. An example of a verbal menu would be the ability to choose from a fixed array of features and values (or value categories) for each feature: hair length (short, medium, long), hair color (black, brown, blonde, gray, white), eye color (blue, green, brown, hazel), etc.

Alternatively, a graphic menu would provide the ability to choose features and/or values for each attribute that are represented graphically. For example, a user sees on the left side of the display of his or her communications terminal a graphic image of a woman. The user taps on the hair of the woman and her hair becomes “selected” on the display. Looking over to the right side of the display, the user sees five patches of color. When the user taps the brown patch, the hair on the graphic image of a woman becomes brown. In a similar manner, values are chosen for eye color, hair length, and other visual attributes of a person.

The construction of verbal feature descriptions may also be accomplished by using a combination of words and images to describe a person. For example, a user could select a verbal representation of a feature, and then select a graphic representation of the value of the feature. As a more specific example, a user could select the word “nose”, view 10 illustrations of various shapes and sizes of noses, and then select the one illustration that best represents the nose of the person being described.

Feature description clusters may be used in all non-biometric Perceptual Addressing methods in which photographs are used. However, the converse is not always true: there are some Perceptual Addressing methods using feature description clusters in which photographs cannot be substituted for feature description clusters.

Advantages of this system are that cameras are not required, people's privacy is not placed at risk because the composite images created do not have enough individual specificity to be used to recognize or positively identify anyone—although they usually have enough specificity to be able to select the “best match to the target” among the relatively small group of people in the perceptual proximity of the user.

### First Embodiment

The most basic method of using feature description clusters is to include multiple features and values of those features described verbally in one data field. For example, a first user might describe himself in a single text field: “male, short, big eyebrows, bushy beard”. Each user would enter a similar description of themselves into their communications terminal (or alternately transmit the description together with their ID or address to a server or data processing system (DPS) which would store the descriptions in a database). These verbal descriptions could be used as a substitute for photographs in any Perceptual Addressing method in which photographs of proximal people and their ID's or addresses are transmitted to a user so that the user can choose a photograph that resembles the intended target of communications.

Following is one example of the use of this type of verbal description in a Perceptual Addressing method. A first user would initiate the process with his communications terminal, by pressing a button for example, which would cause the first user's terminal to transmit via short range wireless transmissions to all proximal communications terminals its own ID/address along with a request to send descriptions of proximal people to the first person's terminal. Upon receiving this request, each proximal communications terminal would sent its ID and verbal description to the first user's communications terminal. Once the first user receives all verbal descriptions of proximal users, he or she can decide which verbal description best corresponds to his or her intended target of communications. Since each verbal description is associated with an ID/address, selecting the best verbal description identifies the associated ID/address with the intended target.

### Second Embodiment

(1) Each person constructs a feature description cluster of their own appearance using their communications terminal, choosing from a verbal menu of features and possible feature values. The feature description cluster is then stored on their communications terminal.

(2) A first person initiates a Perceptual Addressing process in order to send a message to a particular second person that he sees. He initiates the process by pressing a button on his communications terminal which causes his terminal to broadcast its ID/address and a request to each proximal communications terminal to transmit to the first person's ID/address a feature description cluster that describes its user, and also its ID/address.

(3) Each terminal that receives this broadcast automatically transmits to the first person's terminal the feature description cluster of its user along with its ID/address.

(4) The first person's terminal receives each feature description cluster, from each cluster constructs a composite image, and displays each of the composite images to the first person.

(5) The first person selects the composite image that resembles most closely the second person he wants to contact. The first person's terminal associates the selected image with the ID/address associated with the second person.

Variation on this method: First person's terminal requests either feature description clusters (or composite images based on feature description clusters) from a server (or data processing system), instead of from proximal communications terminals. The server determines who is proximal and sends to first person the feature description clusters (or composite images based on feature description clusters) and ID's/addresses of the proximal people. From here on (step 4 above) the method is identical.

### Third Embodiment

(1) Each person constructs a feature description cluster of themselves using their communications terminal and chooses from verbal menus of features and fixed possible feature values; each person's feature description cluster is then stored on his or her communications terminal.

(2) A first person initiates a Perceptual Addressing process in order to communicate with a particular second person that he sees. He initiates the process by constructing a feature description cluster which describes the second person using the same method he used to construct a feature description cluster of himself.

(3) The first person's communications terminal directs to all other communications terminals in the first person's perceptual proximity (for example, via broadcast to proximal terminals, wireless transmission to all local addresses on a wireless network, or via a server which independently determines which terminals are proximal to the first person and forwards the communication to those terminals) its own ID or address, the feature description cluster of the target constructed by the first person, and an optional message from the first person.

(4) Each communication terminal in the first person's proximity receives the communication, and compares the feature description cluster sent by the first person with the feature description cluster constructed by its own user. The comparison process can proceed by any number of ways: for example, the comparison can be executed on a feature by feature basis, each feature match given a predetermined weight, and a match declared if a predetermined matching threshold is attained. If the comparison process yields a match, then the communications terminal transmits that fact along with its ID/address to the address/ID of the first person's terminal.

(5) The first person's terminal then receives the ID's/addresses of the terminal(s) which determined that there was a match of feature description clusters. If only one terminal responds to the first person's broadcast, then the first person's terminal is probably now in possession of the ID or address of the communications terminal of the person he intends to communicate with.

(6) If more than one terminal indicates a feature description cluster match, then a comparison is conducted among the first person's terminal and the terminals indicating a match to determine which terminal has the closest match. After this process, if one terminal does not have a closer match than all other terminals, then other methods of Perceptual Addressing may be used in conjunction with this method to determine which of the best feature description cluster matches actually corresponds to the intended target.

(7) As an optional verification measure, the first person's communications terminal can construct a composite image from the feature description cluster of the second person and then display the composite image to the first person. The first person can then abort the process if the composite image is too dissimilar to the second person, or can approve the communication if the composite image is of reasonable likeness to the second person.

### Fourth Embodiment

This embodiment is similar to the third embodiment except that during the process of Perceptual Addressing communication occurs only between the person initiating the Perceptual Addressing process (a first person and the first person's communications terminal) and a server (or a Data Processing System) in order to determine the ID or communications address of the second person. Once the ID/address of the intended target of communications (the second person) is determined, then communications can be sent to that address either from the server on behalf of the first person, from the first person to the second person via the server, or directly from the first person to the second person.

(1) Each person constructs a feature description cluster of themselves using any device capable of the previously described functions and choosing from menus of descriptions (verbal or graphic) in which there are predefined values to choose from for each feature.

(2) Each person sends his or her ID/address, along with his or her feature description cluster, to a server where it is stored in a database. This sending of information can occur in any number of ways, for example, logging on to a web site on the internet, or transmitting to a server from a cellular telephone.

(3) A first person initiates a Perceptual Addressing process in order to communicate with a particular second person that he sees. He initiates the process by constructing a feature description cluster which describes the second person.

(4) The first person's communications terminal transmits to the server its own ID/address, and the feature description cluster constructed by the first person that describes the second person.

(5) The server receives the communication, and determines the ID's or addresses of the other people in the perceptual proximity of the first person. The technologies for making this determination are well known in the art; however one suggested method is to determine the locations of the communications terminals carried by each person using GPS supplemented with an indoor location tracking method utilizing UltraWideBand.

(6) The server then compares the feature description cluster sent by the first person with the feature description clusters of proximal people stored in its database. The comparison process, as in the previous embodiment, can proceed in any number of ways: for example, the comparison can be executed on a feature by feature basis, each feature match given a predetermined weight. However, the comparison process in this embodiment differs from that in the previous embodiment because the server has access to the feature description clusters of all proximal people (participating in this application), and therefore can determine not only if a comparison process yields a match beyond a specified threshold, but it can also determine the best match. In this situation, both are useful: The ability to determine a best match allows the identification of the ID/address of the person most likely intended by the first person—as compared with merely identifying one or possibly more individuals whose feature description clusters yield a match above a preset criteria level. It is also useful to use a match threshold just in case the server doesn't possess a feature description cluster for the second person in its database; in that case, even if a best match is determined, the best matching feature description cluster may still not closely resemble the feature description cluster of the second person as constructed by the first person. In this way a match threshold will guard against identifying a feature description cluster that is the best match, but is still not a good match.

(7) Once the server determines which feature description cluster of a proximal person in its database is the best acceptable match to the feature description cluster of the second person as described by the first person, then the server determines the associated ID/address in the database of that person.

(8) As an optional verification measure, the server can transmit the matching feature description cluster to the first person's communications terminal, which can then construct a composite image from the feature description cluster and present it to the first person. The first person can then abort the process if the composite image is too dissimilar to the second person, or can approve the communication if the composite image is of reasonable likeness to the second person.

### Fifth Embodiment

This embodiment is similar to the fourth embodiment, except that the determination of the ID's or addresses of proximal people is facilitated by the first person's communications terminal. There are a variety of methods that have been previously described by the current inventor in previous patent applications. Examples are: a) scanning RFID tags worn by people in perceptual proximity to obtain ID's or addresses; or b) broadcasting a request via bluetooth, WiFi, or UltraWideBand (or other digital or analog signal) to the communications terminals of proximal people to transmit back to the requestor (or to transmit directly to the server along with the requestor's ID/address) their ID's or addresses; c) receiving broadcasts from communications terminals in the first person's perceptual proximity of ID's or addresses of those people; or d) logging on to a local wireless network to retrieve the usernames of people on the network. Once the first person's communications terminal determines the ID's/addresses of proximal people, it transmits those ID's/addresses to the server, along with its own ID/address, and the feature description cluster constructed by the first person that describes the second person. From here on, this method is identical to the previous embodiment.

### Sixth Embodiment

(1) Each person constructs a feature description cluster of themselves using their communications terminal by choosing from menus of features (for example, height, build, eye color, complexion, etc.) or by entering a feature that is not present on the menu (for example, a particular person might enter “scarf color”); each person then enters a value for each feature by either selecting from a menu of values (for example for eye color, select from blue, green, or brown) or for each feature enters their own value (for example, for eye color a particular person might enter “pale blue”, or for shoe color might enter “turquoise”); each person's feature description cluster is then stored on their communications terminal.

(2) The first person initiates the Perceptual Addressing process by pressing a button on a first communications terminal, which then broadcasts its ID/address to proximal communications terminals, requesting feature description clusters of their users.

(3) Proximal communications terminals transmit the feature description clusters of their users to the first communications terminal.

(4) The first person's terminal then constructs a menu of features and possible feature values consisting only of features and feature values received from proximal users, and presents this menu to the first person—verbally, graphically, or symbolically. So, for example, if no proximal user specified their “hair color”, then the feature “hair color” does not appear on the menu. On the other hand, if only two proximal users specified “hair color”, and the values they specified for that feature were “black” and “brown”, then “hair color” does appear on the menu. However, the only optional values for “hair color” on the menu are “black” and “brown”. “Blonde” does not appear on the menu because there is no proximal user with that hair color.

(5) The first person then selects from the presented menu the values of the features that describe the intended target person. After each value is selected, then the feature description clusters of proximal people that do not share the selected feature value are removed from the possible features and values in the menu. As a result, after each feature value is selected, the number of features appearing on the menu and the variety of possible feature values is probably reduced. For example, assume there are 6 other people in the first person's perceptual proximity, 3 with brown eyes and 3 with blue eyes. After the first person selects the value “brown” for eye color, then the feature “shoe color” disappears from the menu because the only person that expressed a value for shoe color had blue eyes, and their feature description cluster was removed from the menu because their feature values were not consistent with the feature values selected. In addition, the value of “long” disappears from the menu describing “hair length” and the value of “black metal” disappears from the menu describing “glasses” because the only person that has long hair has blue eyes, and the only person that has black metal glasses has blue eyes.

Thus, menu choices are reduced as selection proceeds, simplifying the process of selecting the feature values of the target person. The first person only has to select feature values until the intended target is distinguished from all other people in the perceptual proximity: depending on the number of people present and the order of menu selection, the first person may need to select only very few features to uniquely describe the intended target. For example, if the first person notices that the target person seems to be the only person in perceptual proximity with red hair, the most strategic way to proceed would be to first choose “chair color” from the feature list and then select “red” for the value of that feature. If the target person is the only person with red hair in the perceptual proximity, then all other menu choices will disappear, and the selection process will have been completed in just one step.

As an additional feature, as each attribute is selected, the first person's communications terminal can indicate how many proximal people fit the criteria of the feature values selected thus far. As more feature values are selected, the number of proximal people (i.e. candidate targets) that are described by the selected feature values decreases until only one person remains.

### Seventh Embodiment

This embodiment is similar to the previous embodiment with the exception that the person initiating the Perceptual Addressing process requests and receives feature description clusters of proximal people not from the communication terminals of those proximal people, but rather from a server (or data processing system).

(1) Each person constructs a feature description cluster of themselves using their communications terminal by choosing from menus of features (for example, height, build, eye color, complexion, etc.) or by entering a feature that is not present on the menu (for example, a particular person might enter “scarf color”); each person then enters a value for each feature by either selecting from a menu of values (for example for eye color, select from blue, green, or brown) or for each feature enters their own value (for example, for eye color a particular person might enter “pale blue”, or for scarf color might enter “red”); each person's feature description cluster is then stored on their communications terminal.

(2) Each person sends his or her ID/address, along with his or her feature description cluster, to a server where it is stored in a database. This sending of information can occur in any number of ways, for example, logging on to a web site on the internet, or transmitting to a server from a cellular telephone.

(3) The first person initiates the Perceptual Addressing process by pressing a button on a first communications terminal, which then transmits its ID/address to the server, requesting feature description clusters of other people in the first person's perceptual proximity.

(4) The server receives the request and then determines which people are in the perceptual proximity of the first person. Two general ways this could be accomplished are: a) the server receives the ID/addresses from the first person's communication terminal in a process described above in the fourth embodiment; or b) the server determines the ID/addresses as described above in the third embodiment, step 5.

(5) The server then transmits to the first person's communications terminal the feature description clusters of all people that have been determined to be in the perceptual proximity of the first person.

(6) The first person's communications terminal receives the feature description clusters of people in the perceptual proximity of the first person and presents to the first person—verbally, graphically, or symbolically—a menu of features and feature values consisting only of those features and feature values that are substantiated in the proximal people. In other words, a feature (e.g. hair color) will not appear on the presented menu if no person in the first person's perceptual proximity expressed a value for that feature (e.g. no person in the first person's perceptual proximity expressed their hair color). In addition, the only values for the features presented will be values that are expressed by the people in the first person's perceptual proximity (e.g. if no user in the first person's perceptual proximity expressed that their hair color is “black”, then the value “black” will not appear on the menu of values for hair color”).

(5) The first person selects from the presented menu the values of the features that describe the intended target person. After each value is selected, then the feature description clusters of proximal people that do not share the selected feature value are removed from the possible features and values in the menu. As a result, after each feature value is selected, the number of features appearing on the menu and the variety of possible feature values is probably reduced.

As an additional advantage of this particular embodiment, the first person only has to select feature values until the intended target is distinguished from all other people in the perceptual proximity: depending on the number of people present and the order of menu selection, the first person may need to select only very few features to uniquely describe the intended target. For example, if the first person notices that the target person seems to be the only person in perceptual proximity with red hair, the a strategic way to proceed would be to first choose “hair color” from the feature list and then select “red” for the value of that feature. If the target person is the only person with red hair in the perceptual proximity, then all other menu choices will disappear, and the selection process will have been completed in just one step.

As an additional feature, as each attribute is selected, the first person's communications terminal can indicate how many proximal people have the feature values selected thus far. As more feature values are selected, the number of proximal people that are described by the selected feature values decreases until only one person remains.

An additional advantage of some variations of this method is that people are not required to carry a communications terminal in order to receive Perceptually Addressed communications.

Note that all prior art seeks to use a single attributes of a target that has a value unique to that target. Examples are football jerseys and license plates, street addresses and telephone numbers, biometric signatures such as delivered by facial recognition techniques and retinal scanning, and precise location methods such as precise GPS determination of a unique location, or the precise aiming of an infrared beam. This class of methods makes use of obvious attributes that are commonly not unique, such as hair color, eye color, height, weight, age, and sex. What enables the success of this method is that, while none of these non-unique attributes may be adequate to uniquely specify a target, if enough of these attributes are combined and applied to targets in a restricted geographic area, most targets may be uniquely determined.

Another key difference from other methods is that each feature value is actually a category which allows aggregation of all members of that category. The process of naming or applying a label to a perceived feature is a process of abstraction and categorization, thus reducing the infinite range of sensory perceptions to a finite set of categories. These categories can then be represented verbally or symbolically. But because they are categories, they may be applied to more than one person.

Part II—Discreet Messaging

[As previously described by the current inventor in the patent applications listed above, Discreet Messaging is a class of methods of facilitating communications among people. Offered here is a more precise description of Discreet Messaging than has been offered in previous patent applications; yet at the same time, the current description is consistent with all previous descriptions and methods of Discreet Messaging given in previous patent applications by the current inventor.]

Discreet Messaging is a specialized form of electronic interpersonal communications in which a first person can initiate the conveying of information specifically to a second person in such a manner that at least a portion of the information will be conveyed to the second person only if the second person initiates the same type of specialized electronic communication specifically with the first person. Each initiated communication that exhibits this behavior is termed a “Discreet Message”. Each Discreet Message consists of (a) a conditional portion—information that will be conveyed to the second person only if the second person initiates a Discreet Message to the first person; and (b) an optional unconditional portion—information that will be conveyed to the second person even if the second person does not initiate a Discreet Message to the first person.

The unconditional portion of a Discreet Message, if there is an unconditional portion, may be constructed by the sender immediately before the initiation of the Discreet Message; alternatively, the unconditional portion of a Discrete Message may be constructed prior to the initiation of the Discrete Message and stored on (a) the sender's communications terminal, (b) the receiver's communications terminal, (c) a data processing system, or (d) some combination of (a), (b), and (c). Similarly, the conditional portion of a Discreet Message may be constructed by the sender immediately before the initiation of the Discreet Message; alternatively, the conditional portion of a Discrete Message may be stored on (a) the sender's communications terminal, (b) the receiver's communications terminal, (c) a data processing system, or (d) some combination of (a), (b), and (c).

1) Feature: Temporarily Deactivate all Outstanding Discreet Messages that can Later be Activated

This feature is a variation of the permanent deactivation feature described the patent applications listed above. Permanent deactivation has the effect of permanently preventing the revealing of conditional portions of Discreet Messages that have not yet been revealed. Deactivation is a desirable feature in case the user no longer is interested in conditionally communicating with the people to whom the user had previously initiated a Discreet Message. For example, if a woman was actively dating and had issued five outstanding Discreet Messages to men who had not yet reciprocated (and therefore had not yet received her conditional indication of interest), it is possible that at any time one of those men might notice her, become interested in getting to know her, and send her a Discreet Message, thus reciprocating her Discreet Message to him. This might be awkward if in the meantime the woman had married and would never again be interested in any of those five men. This is the need that was anticipated when the permanent deactivation feature was conceived. However, there is another need: the woman may start seriously dating one man, but may not yet determine if the relationship will last. She needs to prevent the untimely reciprocation of one of her outstanding Discreet Messages during this relationship; but if her current relationship with the man doesn't work, she may want to re-activate all outstanding Discreet Messages to keep those possibilities alive—hence the need for the temporary deactivation feature.

In Discreet Messaging, records are kept of all outstanding (unreciprocated) Discreet Messages. These records, depending upon the Discreet Messaging system, can be stored on the user's telecommunications terminal, the recipient's telecommunications terminal, and/or on a server (or more generally, a data processing system). Within each record is kept the ID or address (explicit or implied by the location of the stored record) of the sender and recipient of each Discreet Message. In the case of permanent deactivation of Discreet Messages, the user can issue a command that sends a message to all of the parties storing such records and a request that those records be deleted. In the case of temporary deactivation of Discreet Messages, the request can be that such records will be ignored until such time as either (a) notice is received to re-activate the record, or (b) the record expires according to the original expiration date of the Discreet Message and should be deleted, or (c) a new expiration date is received with the request for temporary deactivation such that the record should be deleted upon the new expiration date in the case that the record is not reactivated before that time.

2) Feature: Sender can Choose Timing of the Conveying to the Recipient of the Unconditional Portion of a Discreet Message to Help Mask the Sender's Identity.

If the purpose of a Discreet Message is to conceal the identity of the sender until the Discreet Message is reciprocated, and a form of Discreet Messaging is used in which there is an unconditional component of the communication, and it is used in combination with Perceptual Addressing, then a problem arises if there are only two or three people in a common space. If, for example, a second person is in a cafe, and she receives an unconditional portion of a Discreet Message indicating that someone is interested in meeting her—and there is only one other person, a first person, in the cafe—then she can easily deduce the identity of the sender. In addition, the first person, understanding the logic of the system would know that the second person can easily deduce that he is the person that expressed interest in her. If she decides not to reciprocate the Discreet Message, then the first person will feel rejected.

This problem can be circumvented if the first person can delay the revealing of the unconditional portion of the Discreet Message to a time when the second person cannot as easily deduce the identity of the sender. Thus, this additional feature of Discreet Messaging consists in adding a time of revealing field for the unconditional portion (if there is an unconditional portion of the Discreet Messaging system being used) of a Discreet Message. This time of revealing can be entered in terms of a date and time, or alternatively can be entered in terms of a delay (in any unit of time) from the current time. For example, if a first person is alone in a cafe with a second person, he might enter an hour delay in the delivery of the unconditional portion of his Discreet Message to the second person. It should be noted, however, that the delay of revealing of the unconditional message would be deactivated in the case that the second person had previously sent a Discreet Message to the first person. In that case, all communications to both parties would be revealed immediately.

3) Feature: “Ping”—Unconditional Portion of Discreet Message that Contains No Information Other than its Existence. [See USPTO Document Disclosure # 590923, Nov. 30, 2005]

This is a specialized form of Discreet Messaging used with Perceptual Addressing in which the unconditional portion of the Discreet Message contains no information other than the existence of a Discreet Message. This unconditional portion of a Discreet Message that contains no information is labeled “ping”. When a ping is received, the user can be given the option to be notified in any number of ways: For example, a user's mobile communications terminal could emit a sound (termed a “ping tone”), or could vibrate, or a user could receive an email, etc.

This feature is useful for the following reason. If an application of Discreet Messaging has no unconditional portion of Discreet Messages, then users may only get infrequent indications that the application is working because they would receive indications of interest from other people only if both parties mutually expressed interest by sending Discreet Messages. In fact, mutual expressions of interest may be so infrequent for some people, that they will rarely receive any indication that the application is working and consequently they may lose interest in the application altogether. One remedy to this problem is to include an unconditional portion of the Discreet Message to increase the frequency that users will receive indications that the application is working. Even though some users may not be interested in including an unconditional portion in Discreet Messages they send, to send a ping may satisfy their desire not to convey any unconditional information, and at the same time may give other users the feedback they need to be assured that the application is working and that other people are sometimes interested in communicating with them.

4) Feature: “Ping Counter” [see USPTO Document Disclosure # 590923, Nov. 30, 2005]

This feature, used in combination with Perceptual Addressing, is the ability to record, summarize, and display to users the number of unconditional portions of Discreet Messages received, organized by time period received (or time period sent), location received (or location sent), or any other category or variable created by the user such as hairstyle when pings received, clothing worn when pings received, people the user was with when pings received, etc. (It should be noted that the term “Ping Counter” is used to indicate the function of counting all forms of unconditional portions of Discreet Messages received—not just pings.)

Without the functionality of a Ping Counter, the reasons for a user to engage in Discreet Messaging are to reduce risk in communicating with another person, and also as a sophisticated type of filter that can eliminate messages received from people other than the specific people that the user has sought out. The Ping Counter provides an additional reason for a user to engage in Discreet Messaging: to receive feedback and understanding of when, where, and why he or she attracts varying degrees of interest from other people.

For example, if a woman wants to know which blouse helps to attract more attention, she would create a category “clothing”, and then each morning after she dresses she would enter into her communications terminal the clothing she is wearing, e.g. “red blouse, white pants”. Her communications terminal then counts the number of unconditional portions of Discreet Messages she receives while wearing the “red blouse, white pants”. She does this every day, wearing a different outfit each day. After one week, her communications terminal displays to her seven different outfits and the output from the Ping Counter for each outfit. She then notes that, for example, the count was highest when she wore “white blouse, black pants”. But before she jumps to a conclusion about her clothing, she checks to see which day and which location she received the highest count. Then she realizes that the day she was wearing the “white blouse, black pants” was a Friday, and the location that received the highest count was a nightclub that she attended on Friday night. Thus she concludes that the location probably had more to do with the high Ping Count than the outfit. As a result, not only does she attend the nightclub more often, but she also attends more to the Ping Counter.

To implement this feature, it is necessary for either the user's communications terminal, or a server (data processing system) on behalf of the user, to track the time and the location of the user for each counter registered by the Ping Counter—both capabilities that are well known in the art. It is also necessary to allow a user to input other “current status” variables such as what the user is currently wearing. If the user's communications terminal is recording the variables that co-vary with the receipt of unconditional portions of Discreet Messages received, then the user need only enter the value of those variables into his or her communications terminal. If a server is recording the variables that co-vary with the receipt of unconditional portions of Discreet Messages received, then the user's communications terminal can forward those values to the server. Alternative methods of getting the current values of those variables to the server—such as logging onto an associated web site from any internet terminal and entering the information there—are also viable means of operation.

Regarding the tracking of location, there are two general ways this may be accomplished: (a) A user enters a location into the system in the same way the user enters other current status variables; and (b) GPS, cellular telephone triangulation or other location tracking system allows the automatic tracking of the user's location.

Depending upon the specific implementation of this invention, there needs to be restrictions placed on how often one person could cause another person's mobile device to emit a ping tone and advance its ping counter. The need for this restriction is obvious if one considers that without any restrictions, one person could ping another 100 times within five minutes and render the output of their ping counter meaningless. One remedy is to for a mobile device to emit a ping tone and advance its ping counter when receiving an unconditional portion of a Discreet Message from a particular other person only once within a set period of time, 24 hours for example, determined by the implementation of the specific system. Another remedy might be to tie the restriction of how often a ping counter advances to when a Discreet Message expires: a new unconditional portion of a Discreet Message may be sent, received, and counted only after a previous Discreet Message from the same sender to the same receiver has expired. Of course, the various aspects of ping notification and ping counting could be de-coupled, and different restrictions on the frequency of one sender pinging a specific recipient could be set-up for (a) the notification of receipt of an unconditional portion of a Discreet Message, (b) the registration of the date and time of its receipt, (c) whether or not the receipt of a specific unconditional portion of a Discreet Message is incorporated into the displayed count on a ping counter, and (d) the expiration of a Discreet Message.

What is claimed is:

1. A system of facilitating the specification of an observed target, comprising:
means for receiving sets of information, each set comprising information descriptive of multiple observable features of one of a plurality of targets;
means for storing the sets of information;
means for receiving from a first user a first set of information comprising one or more feature values, each feature value describing an observable feature of a first target occupying a first spatial region during at least a portion of a first time period;
means for retrieving descriptive feature information of candidate targets, wherein candidate targets occupy the first spatial region during at least a portion of the first time period;
transmitting descriptive feature information among spatially separated components of the system to allow information in the first set to be compared with information descriptive of features of candidate targets;
means of comparing at least a portion of the first set to at least a portion of the descriptive information of candidate targets; and
means of determining the one or more candidate targets that have sets of descriptive feature information that are consistent with the first set;

2. The system of claim 1 further comprising
means of determining an ID/address associated with the one candidate target that has a set of descriptive feature information that best matches the first set;

3. A system comprising:
multiple target devices that have either the capability of detecting and reporting their own position, or the capability of responding to local wireless communications indicating their proximity to a particular user.
a data processing system that receives for each target a set of indications of multiple descriptive categories depicting the appearance of the target;
a first device that receives from a first person a first set of descriptive categories depicting the appearance of a target that is in a first spatial region during at least a portion of a first time period;

4. A system comprising:
a first device that receives from a first person a first set of indications of multiple descriptive categories depicting the appearance of a second person that is in a first spatial region during at least a portion of a first time period;
a second device that receives from a second person a second set of indications of multiple descriptive categories uniquely depicting the appearance of a first person that is in a first spatial region during at least a portion of a first time period;
a data processing system that directs to the second person a second communication associated with the first person and directs to the first person a first communication associated with the second person only after both the first and second devices receive respective first and second set of indications, wherein prior to both the first and second mobile devices receiving respective first and second indications at least a portion of the information in each of the first and second communications are not directed to the respective first and second persons.
